(19) United States
(12) Patent Application Publication
(10) Pub. No.: US 2021/0031806 A1
(43) Pub. Date: Feb. 4, 2021

(54) URGENT VEHICLE DRIVING SYSTEM, SERVER DEVICE, AND URGENT VEHICLE DRIVING PROGRAM

(71) Applicant: TOYOTA JIDOSHA KABUSHIKI KAISHA, Toyota-shi (JP)

(72) Inventors: Kohta TARAO, Nagoya-shi (JP); Hiroki AWANO, Tokyo-to (JP); Kuniaki JINNAI, Nagoya-shi (JP); Yoshihiro MAEKAWA, Toyota-shi (JP)

(73) Assignee: TOYOTA JIDOSHA KABUSHIKI KAISHA, Toyota-shi, Aichi-ken (JP)

(21) Appl. No.: 16/936,135

(22) Filed: Jul. 22, 2020

(30) Foreign Application Priority Data
Jul. 29, 2019 (JP) 2019-138982

(51) Int. Cl. B60W 60/00; G05D 1/00; B60W 30/09

(52) U.S. Cl. CPC B60W 60/0051; B60W 60/0016; B60W 30/09; G05D 1/0061; G05D 1/0011

(57) ABSTRACT

An urgent vehicle driving system includes: an acquisition unit that acquires driving information relating to a driving state of a first vehicle that is an urgent vehicle; and a switching unit that, on the basis of the driving information acquired by the acquisition unit, switches a second vehicle, which is in a manual driving mode or a remote driving mode and is located within a predetermined range from the first vehicle, to an autonomous driving mode configured to avoid the first vehicle.

### CROSS-REFERENCE TO RELATED APPLICATION

This application is based upon and claims the benefit of priority of the prior Japanese Patent Application No. 2019-138982, filed on Jul. 29, 2019, the entire contents of which are incorporated herein by reference.

### BACKGROUND

### Technical Field

The embodiments discussed herein are related to an urgent vehicle driving system, a server device, and an urgent vehicle driving program.

### Related Art

Japanese Patent Application Laid-open (JP-A) No. 2018-151208 discloses a self-driving assistance device which, when it is detected by an urgent vehicle detection unit that an urgent vehicle is approaching the host vehicle when the vehicle is being driven in a self-driving mode, changes, in accordance with the condition of the driver, the driving route of the host vehicle to a driving route that does not coincide with the driving route of the urgent vehicle.

In the self-driving assistance device described in JP-A No. 2018-151208, consideration is given only to moving a vehicle being driven in a self-driving mode out of the way of the urgent vehicle. In other words, no consideration is given to whether or not a vehicle being driven in a manual driving mode in the vicinity of the urgent vehicle is to be moved out of the way of the urgent vehicle, and so there is room for improvement in terms of allowing the urgent vehicle to drive smoothly.

### SUMMARY

The present disclosure has been devised in view of the above, and it is an object thereof to provide an urgent vehicle driving system, a server device, and an urgent vehicle driving program that can smoothly move a vehicle that is in the vicinity of an urgent vehicle out of the way of the urgent vehicle regardless its driving mode.

An urgent vehicle driving system pertaining to a first aspect of the disclosure includes: an acquisition unit that acquires driving information relating to a driving state of a first vehicle that is an urgent vehicle; and a switching unit that, on the basis of the driving information acquired by the acquisition unit, switches a second vehicle, which is in a manual driving mode or a remote driving mode and is located within a predetermined range from the first vehicle, to an autonomous driving mode configured to avoid the first vehicle.

In the urgent vehicle driving system pertaining to the first aspect, the acquisition unit acquires the driving information relating to the driving state of the first vehicle that is an urgent vehicle. As the driving information relating to the driving state of the first vehicle, for example, the driving route, driving speed, and destination of the first vehicle are acquired. Moreover, on the basis of the driving information acquired by the acquisition unit, the switching unit switches the second vehicle being driven in the manual driving mode or the remote driving mode and located within the predetermined range from the first vehicle to the autonomous driving mode configured to avoid the first vehicle. Because of this, the second vehicle is driven in the autonomous driving mode in avoidance of the first vehicle. For this reason, the second vehicle being driven in the manual driving mode or the remote driving mode in the vicinity of the first vehicle that is an urgent vehicle can be smoothly moved out of the way of the first vehicle.

An urgent vehicle driving system pertaining to a second aspect of the disclosure includes: an acquisition unit that acquires driving information relating to a driving state of a first vehicle that is an urgent vehicle; and a switching unit that, on the basis of the driving information acquired by the acquisition unit, switches a second vehicle, which is in a manual driving mode or an autonomous driving mode and is located within a predetermined range from the first vehicle, to a remote driving mode configured to avoid the first vehicle.

In the urgent vehicle driving system pertaining to the second aspect, the acquisition unit acquires the driving information relating to the driving state of the first vehicle that is an urgent vehicle. As the driving information relating to the driving state of the first vehicle, for example, the driving route, driving speed, and destination of the first vehicle are acquired. Moreover, on the basis of the driving information acquired by the acquisition unit, the switching unit switches the second vehicle being driven in the manual driving mode or the autonomous driving mode and located within the predetermined range from the first vehicle to the remote driving mode configured to avoid the first vehicle. Because of this, the second vehicle is driven in the remote driving mode in avoidance of the first vehicle. For this reason, the second vehicle being driven in the manual driving mode or the autonomous driving mode in the vicinity of the first vehicle that is an urgent vehicle can be smoothly moved out of the way of the first vehicle.

An urgent vehicle driving system pertaining to a third aspect is the urgent vehicle driving system of the first aspect, wherein the switching unit is provided at the second vehicle or at a server device.

In the urgent vehicle driving system pertaining to the third aspect, the switching unit is provided at the second vehicle or at the server device. Because of this, the switching unit provided at the second vehicle or at the server device can switch, on the basis of the driving information acquired by the acquisition unit, the second vehicle to the autonomous driving mode configured to avoid the first vehicle.

An urgent vehicle driving system pertaining to a fourth aspect is the urgent vehicle driving system of the second aspect, wherein the switching unit is provided at a remote center at which remote driving of the second vehicle is performed.

In the urgent vehicle driving system pertaining to the fourth aspect, the switching unit is provided at the remote center that performs remote driving of the second vehicle. Because of this, the switching unit provided in the remote center can switch, on the basis of the driving information acquired by the acquisition unit, the second vehicle to the remote driving mode configured to avoid the first vehicle.

An urgent vehicle driving system pertaining to a fifth aspect is the urgent vehicle driving system of the first aspect or the second aspect, wherein the acquisition unit is provided at a road on which the first vehicle is driving.

In the urgent vehicle driving system pertaining to the fifth aspect, the acquisition unit is provided at the road on which the first vehicle that is an urgent vehicle is driving. Because of this, the acquisition unit can acquire the driving information relating to the driving state of the first vehicle by, for example, communication with the first vehicle or an imaging unit that images the first vehicle.

An urgent vehicle driving system pertaining to a sixth aspect is the urgent vehicle driving system of the first aspect or the second aspect, wherein the acquisition unit is provided at the second vehicle, and the driving information is acquired by communication between the first vehicle and the second vehicle.

In the urgent vehicle driving system pertaining to the sixth aspect, the acquisition unit is provided at the second vehicle, so there is no need to provide a new acquisition unit outside the second vehicle, which makes it possible to lower costs. Because of this, the acquisition unit can acquire the driving information relating to the driving state of the first vehicle by communication between the first vehicle and the second vehicle.

An urgent vehicle driving system pertaining to a seventh aspect is the urgent vehicle driving system pertaining to the first aspect or the second aspect, further including an urgent state detection unit that detects an urgent state of the first vehicle, wherein the acquisition unit acquires the driving information in a case in which the urgent state detection unit has detected that the first vehicle is in an emergency state.

The urgent vehicle driving system pertaining to the seventh aspect has the urgent state detection unit that detects an urgent state of the first vehicle, and it is detected by the urgent state detection unit that the first vehicle is in an emergency state. In a case where it is has been detected by the urgent state detection unit that the first vehicle is in the emergency state, that is, that the first vehicle has become an urgent vehicle, the acquisition unit acquires the driving information relating to the driving state of the first vehicle. For this reason, the driving information relating to the driving state of the first vehicle can be acquired at an early stage.

An urgent vehicle driving system pertaining to an eighth aspect is the urgent vehicle driving system of the seventh aspect, wherein the urgent state detection unit is an emergency button that is provided inside the first vehicle and that is pushed at a time of an emergency.

In the urgent vehicle driving system pertaining to the eighth aspect, the emergency button is provided inside the first vehicle, so when the emergency button is pushed when there is an emergency, it can be detected at an early stage that the first vehicle is in an emergency state, that is, that the first vehicle has become an urgent vehicle.

An urgent vehicle driving system pertaining to a ninth aspect is the urgent vehicle driving system of the seventh aspect, wherein the urgent state detection unit is a biometric information detection unit that is configured to detect an abnormal state in a driver of the first vehicle.

In the urgent vehicle driving system pertaining to the ninth aspect, the biometric information detection unit that detects an abnormal state in the driver of the first vehicle is provided, so an abnormal state in the driver of the first vehicle is detected by the biometric information detection unit. Because of this, it can be detected at an early stage that the first vehicle is in an urgent state, that is, that the first vehicle has become an urgent vehicle.

An urgent vehicle driving system pertaining to a tenth aspect is the urgent vehicle driving system of the first aspect or the second aspect, further including a notification unit that notifies an occupant inside the second vehicle of the presence of the first vehicle.

The urgent vehicle driving system pertaining to the tenth aspect has the notification unit that notifies the occupant inside the second vehicle of the presence of the first vehicle, so the occupant inside the second vehicle can be notified at an early stage by the notification unit of the presence of the first vehicle that is an urgent vehicle.

An urgent vehicle driving system pertaining to an eleventh aspect is the urgent vehicle driving system of the second aspect, wherein the remote center, at which remote driving of the second vehicle is performed, is provided with a display unit that displays, in bird's-eye view, travel of the first vehicle and the second vehicle.

In the urgent vehicle driving system pertaining to the eleventh aspect, the remote center is provided with the display unit that displays in bird's-eye view the driving of the first vehicle and the second vehicle, so the second vehicle can be driven in the remote driving mode so as to avoid the first vehicle that is an urgent vehicle.

A server device pertaining to a twelfth aspect includes: an acquisition unit that acquires driving information relating to a driving state of a first vehicle that is an urgent vehicle; and a switching unit that, on the basis of the driving information acquired by the acquisition unit, switches a second vehicle, which is in a manual driving mode or a remote driving mode and is located within a predetermined range from the first vehicle, to an autonomous driving mode configured so as to avoid the first vehicle.

In the server device pertaining to the twelfth aspect, the acquisition unit acquires the driving information relating to the driving state of the first vehicle that is an urgent vehicle. As the driving information relating to the driving state of the first vehicle, for example, the driving route, driving speed, and destination of the first vehicle are acquired. Moreover, on the basis of the driving information acquired by the acquisition unit, the switching unit switches the second vehicle being driven in the manual driving mode or the remote driving mode and located within the predetermined range from the first vehicle to the autonomous driving mode configured so as to avoid the first vehicle. Because of this, the second vehicle is driven in the autonomous driving mode in avoidance of the first vehicle. For this reason, the second vehicle being driven in the manual driving mode or the remote driving mode in the vicinity of the first vehicle that is an urgent vehicle can be smoothly moved out of the way of the first vehicle.

An urgent vehicle driving program pertaining to a thirteenth aspect causes a computer to execute: a step of acquiring driving information relating to a driving state of a first vehicle that is an urgent vehicle; and a step of switching, on the basis of the driving information, a second vehicle being driven in a manual driving mode or a remote driving mode and located within a predetermined range from the first vehicle to an autonomous driving mode configured so as to avoid the first vehicle.

An urgent vehicle driving control device pertaining to a fourteenth aspect includes a memory and a processor connected to the memory, wherein the processor is configured to acquire driving information relating to a driving state of a first vehicle that is an urgent vehicle and, on the basis of the driving information, switch a second vehicle being driven in a manual driving mode or a remote driving mode and located within a predetermined range from the first vehicle to an autonomous driving mode configured so as to avoid the first vehicle.

An urgent vehicle driving method pertaining to a fifteenth aspect includes: a step of acquiring driving information relating to a driving state of a first vehicle that is an urgent vehicle; and a step of switching, on the basis of the driving information, a second vehicle being driven in a manual driving mode or an autonomous driving mode and located in a predetermined range from the first vehicle to a remote driving mode configured to avoid the first vehicle.

An urgent vehicle driving method pertaining to a sixteenth aspect includes: a step of acquiring driving information relating to a driving state of a first vehicle that is an urgent vehicle; and a step of switching, on the basis of the driving information, a second vehicle being driven in a manual driving mode or a remote driving mode and located in a predetermined range from the first vehicle to an autonomous driving mode configured to avoid the first vehicle.

According to the urgent vehicle driving control device pertaining to the disclosure, a vehicle that is in the vicinity of an urgent vehicle can be smoothly moved out of the way of the urgent vehicle regardless of its driving mode.

### BRIEF DESCRIPTION OF THE DRAWINGS

FIG. 1 is a drawing showing the schematic configuration of an urgent vehicle driving system pertaining to a first embodiment;

FIG. 2 is a block diagram showing the hardware configuration of devices installed in vehicles;

FIG. 3 is a block diagram showing an example of the functional configuration of the vehicles;

FIG. 4 is a block diagram showing the hardware configuration of an acquisition device;

FIG. 5 is a block diagram showing an example of the functional configuration of the acquisition device;

FIG. 6 is a block diagram showing the hardware configuration of a server device;

FIG. 7 is a block diagram showing an example of the functional configuration of the server device;

FIG. 8 is a flowchart showing the flow of an urgent vehicle driving control process performed by the devices installed in the vehicles;

FIG. 9 is a flowchart showing the flow of an urgent vehicle driving control process performed by the acquisition device;

FIG. 10 is a flowchart showing the flow of an urgent vehicle driving control process performed by the server device;

FIG. 11 is a drawing showing, in a bird's-eye view, plural vehicles driving on a road;

FIG. 12 is a drawing showing the schematic configuration of an urgent vehicle driving system pertaining to a second embodiment;

FIG. 13 is a block diagram showing the hardware configuration of devices installed in a remote operation device;

FIG. 14 is a block diagram showing an example of the functional configuration of the remote operation device;

FIG. 15 is a flowchart showing the flow of an urgent vehicle driving control process performed by the remote operation device;

FIG. 16 is a drawing showing an image that is displayed on a display device of the remote operation device and in which plural vehicles are driving on a road; and

FIG. 17 is a block diagram showing an example of the functional configuration of vehicles in an urgent vehicle driving system pertaining to a third embodiment.

### DESCRIPTION OF EMBODIMENTS

Examples of embodiments of the disclosure will be described below with reference to the drawings. It will be noted that identical or equivalent constituent elements and parts in the drawings are assigned identical reference signs.

### First Embodiment

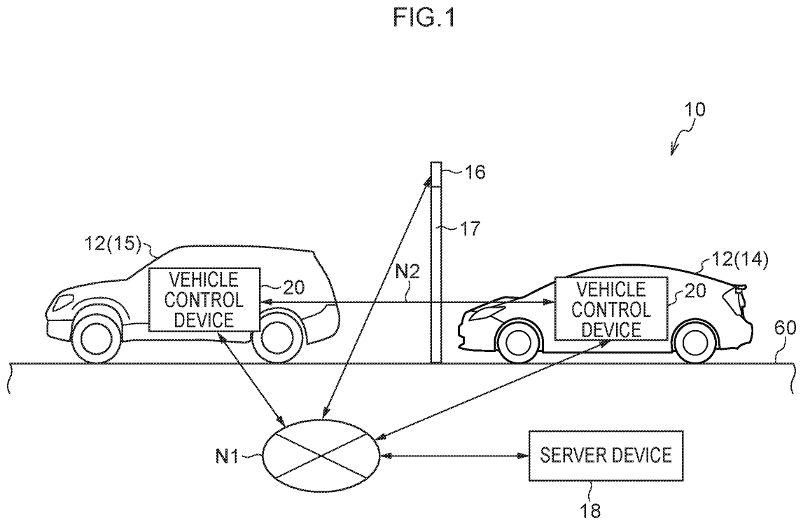

FIG. 1 is a drawing showing the schematic configuration of an urgent vehicle driving system 10 pertaining to a first embodiment.

As shown in FIG. 1, the urgent vehicle driving system 10 is configured to include plural vehicles 12, an acquisition device 16, and a server device 18. The plural vehicles 12 include a first vehicle 14 that is an urgent vehicle and a second vehicle 15 that is located in a predetermined range from the first vehicle 14.

The first embodiment describes as an example a case where, as shown in FIG. 1, the plural vehicles 12 are driving on a road 60 in which the direction of travel is the same. FIG. 1 shows the vehicles 12 sorted by reference signs into the first vehicle 14 and the second vehicle 15, but in cases where no distinction is made between the first vehicle 14 and the second vehicle 15, they will be described as “the vehicles 12.”

The acquisition device 16 acquires driving information relating to the driving state of the first vehicle 14 that is an urgent vehicle. The acquisition device 16 is an example of an acquisition unit. The acquisition device 16 is provided on the road 60 on which the plural vehicles 12 are driving. For example, the acquisition device 16 is attached to a frame 17 that extends upward from the side of the road 60. It will be noted that although illustration thereof is omitted, the acquisition device 16 is installed in multiple locations at predetermined intervals (i.e., preset intervals) on the road 60.

The first vehicle 14 and the second vehicle 15 each have a vehicle control device 20. In the urgent vehicle driving system 10, the vehicle control device 20 of the first vehicle 14, the vehicle control device 20 of the second vehicle 15, the acquisition device 16, and the server device 18 are connected to each other via a network N1. Furthermore, the vehicle control devices 20 are configured to be capable of directly communicating with each other by vehicle-to-vehicle communication N2. The server device 18 is an example of an urgent vehicle driving control device.

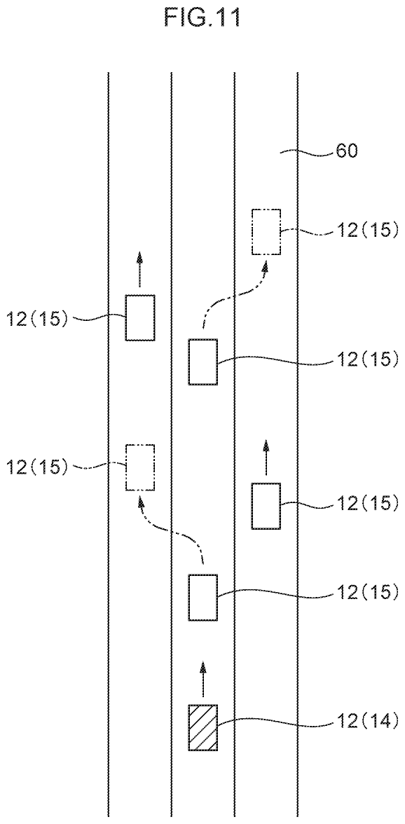

In FIG. 1, only the first vehicle 14 that is an urgent vehicle and the second vehicle 15 driving in front of the first vehicle 14 are shown, but in reality there are plural second vehicles 15 driving in the vicinity of the first vehicle 14 (see FIG. 11). It will be noted that although the urgent vehicle driving system 10 shown in FIG. 1 is configured to include one server device 18, it may also include two or more server devices 18.

In the first embodiment, the vehicles 12 are each configured to be capable of executing a self-driving mode (namely, an autonomous driving mode) in which the vehicle 12 drives autonomously on the basis of a driving plan generated by the vehicle control device 20, a remote driving mode based on operation of a remote operation device (not shown in the drawings) by a remote driver, and a manual driving mode based on operation by an occupant (i.e., a driver) of the vehicle 12. It will be noted that the vehicles 12 may also have a configuration in which they do not perform the remote driving mode based on operation of the remote operation device (not shown in the drawings) by the remote driver.

(Vehicles)

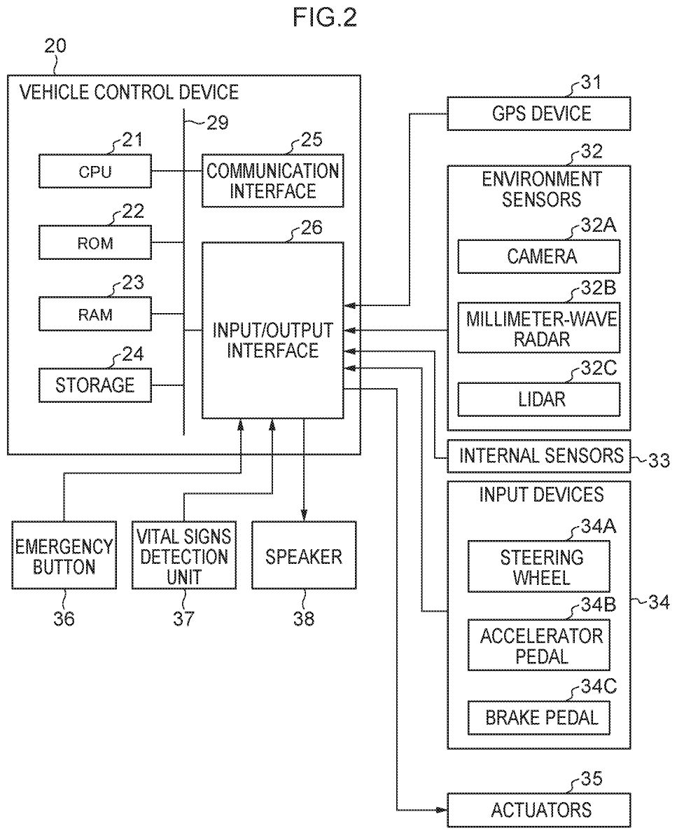

FIG. 2 is a block diagram showing the hardware configuration of devices installed in the vehicles 12. It will be noted that although the vehicles 12 of the first embodiment have the same configuration in terms of the first vehicle 14 and the second vehicle 15, the first vehicle 14 may also have a different configuration. As shown in FIG. 2, each of the vehicles 12 has, in addition to the vehicle control device 20, a Global Positioning System (GPS) device 31, environment sensors (i.e., external sensors) 32, internal sensors 33, input devices 34, actuators 35, an emergency button 36, a vital signs detection unit (i.e., a vital signs sensor) 37, and a speaker 38.

The vehicle control device 20 has a central processing unit (CPU) 21, a read-only memory (ROM) 22, a random-access memory (RAM) 23, a storage 24, a communication interface (I/F) 25, and an input/output interface (I/F) 26. The CPU 21, the ROM 22, the RAM 23, the storage 24, the communication interface 25, and the input/output interface 26 are communicably connected to each other via a bus 29.

The CPU 21 executes various types of programs and controls each part. The CPU 21 reads the programs from the ROM 22 or the storage 24 and executes the programs using the RAM 23 as a work area. The CPU 21 controls each of the above configurations and performs various types of processing in accordance with the programs recorded in the ROM 22 or the storage 24. In the first embodiment, an urgent vehicle driving program is stored in the ROM 22 or the storage 24.

The ROM 22 stores various types of programs and various types of data. The RAM 23 temporarily stores the programs or data as a work area.

The storage 24 is configured by a hard disk drive (HDD) or a solid-state drive (SSD) and stores various types of programs, including an operating system, and various types of data.

The communication interface 25 includes an interface for connecting to the network N1 in order to communicate with the other vehicle control devices 20, the acquisition device 16, and the server device 18. The interface uses a communication standard (namely, protocol) such as LTE or Wi-Fi (Wi-Fi is a registered trademark in Japan), for example. Furthermore, the communication interface 25 includes a wireless device for directly communicating with the other vehicle control devices 20 by the vehicle-to-vehicle communication N2 utilizing dedicated short-range communications (DSRC), for example.

The communication interface 25 acquires driving information of the other vehicles 12 that are in the vicinity of the vehicle 12 by the vehicle-to-vehicle communication N2 (see FIG. 1). The driving information includes, for example, the driving directions, driving speeds, destinations, and driving routes of the other vehicles 12 as well as the distance between the vehicle 12 and the other vehicles 12.

The input/output interface 26 is an interface for communicating with each of the devices installed in the vehicle 12. The GPS device 31, the environment sensors 32, the internal sensors 33, the input devices 34, the actuators 35, the emergency button 36, the vital signs detection unit 37, and the speaker 38 are connected via the input/output interface 26 to the vehicle control device 20. It will be noted that the GPS device 31, the environment sensors 32, the internal sensors 33, the input devices 34, the actuators 35, the emergency button 36, the vital signs detection unit 37, and the speaker 38 may also be directly connected to the bus 29.

The GPS device 31 is a device that locates the current position of the vehicle 12. The GPS device 31 includes an antenna (not shown in the drawings) that receives signals from GPS satellites.

The environment sensors 32 are a group of sensors that detect area information about the area around the vehicle 12. The environment sensors 32 include a camera 32A that images a predetermined range, a millimeter wave radar 32B that transmits exploration waves in a predetermined range and receives the reflected waves, and a lidar (laser imaging detection and ranging) 32C that scans a predetermined range. It will be noted that it is preferable to have more than one camera 32A. In this case, a first camera 32A may be configured to capture an image in the forward direction of the vehicle 12, and a second camera 32A may be configured to capture an image in the rearward direction of the vehicle 12. Furthermore, one of the plural cameras 32A may be a visible light camera and the other may be an infrared camera.

The internal sensors 33 are a group of sensors that detect the driving state of the vehicle 12. The internal sensors 33 include at least one of a vehicle speed sensor, an acceleration sensor, and a yaw rate sensor.

The input devices 34 are a group of switches for the occupant riding in the vehicle 12 to operate. The input devices 34 include a steering wheel 34A serving as a switch that steers a steering wheel of the vehicle 12, an accelerator pedal 34B serving as a switch that accelerates the vehicle 12, and a brake pedal 34C serving as a switch that decelerates the vehicle 12.

The actuators 35 include a steering wheel actuator that drives the steering wheel of the vehicle 12, an accelerator actuator that controls the acceleration of the vehicle 12, and a brake actuator that controls the deceleration of the vehicle 12.

The emergency button 36 is a push button that is provided inside the vehicle 12 and is pushed when there is an emergency. The emergency button 36 is an example of an urgent state detection unit. In the vehicle 12, when the emergency button 36 is pushed when the occupant inside the vehicle 12 has an emergency, it is detected that the vehicle 12 is in an urgent state.

The vital signs detection unit (for example, the biometric information detection unit) 37 detects the vital signs of the occupant, such as the driver, of the vehicle 12. As the vital signs, any one or more of the heart rate, blood pressure, pulse, electrocardiogram, and pupils of the occupant are detected. In the first embodiment, as the vital signs detection unit 37, any one or more of a heart rate sensor that detects the heart rate of the occupant of the vehicle 12, a blood pressure sensor that detects the blood pressure of the occupant, a pulse sensor that detects the pulse of the occupant, an electrocardiogram sensor that detects the electrocardiogram of the occupant, and a camera that images the pupils of the occupant are provided. The vital signs detection unit 37 may be provided inside the vehicle 12 or may be a portable terminal portably carried by the driver of the vehicle 12.

The speaker 38 outputs, by audio, some of the information transmitted from the server device 18. Examples of the information transmitted from the server device 18 include information indicating the presence of the first vehicle 14 that is an urgent vehicle, and the information indicating the presence of the first vehicle 14 that is an urgent vehicle is output by audio to the second vehicles 15 that are in the predetermined range around the first vehicle 14.

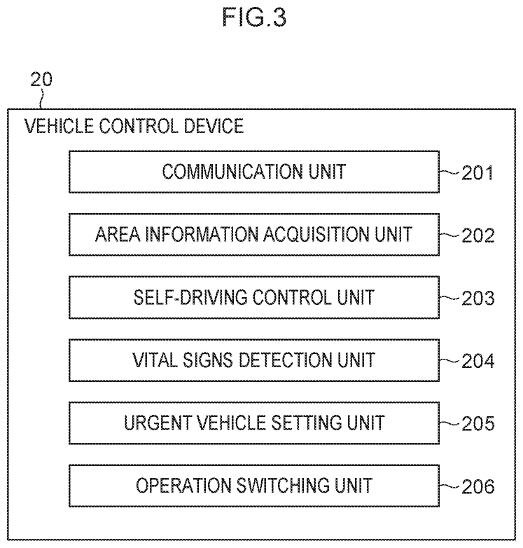

FIG. 3 is a block diagram showing an example of the functional configuration of the vehicle control device 20.

As shown in FIG. 3, the vehicle control device 20 has a communication unit 201, an area information acquisition unit 202, a self-driving control unit (for example, an autonomous driving control unit) 203, a vital signs detection unit (for example, the biometric information detection unit) 204, an urgent vehicle setting unit 205, and an operation switching unit 206. The communication unit 201, the area information acquisition unit 202, the self-driving control unit 203, the vital signs detection unit 204, the urgent vehicle setting unit 205, and the operation switching unit 206 are realized by the CPU 21 reading and executing the urgent vehicle driving program stored in the ROM 22 or the storage 24.

The communication unit 201 performs communication with the other vehicles 12, communication with the acquisition device 16, and communication with the server device 18.

The area information acquisition unit 202 acquires the area information about the area around the vehicle 12. The area information acquisition unit 202 acquires the area information about the area around the vehicle 12 from the environment sensors 32 via the input/output interface 26. Furthermore, the area information acquisition unit 202 receives the area information about the area around the vehicle 12 by the vehicle-to-vehicle communication N2. The area information includes information not only about the other vehicles 12 driving in the vicinity of the vehicle 12 and pedestrians but also the weather, brightness, lane width, and obstacles. Furthermore, the area information includes information such as the driving directions, driving speeds, destinations, and driving routes of the other vehicles 12 driving in the vicinity of the vehicle 12 as well as the distances between the plural vehicles 12. Moreover, the area information includes meteorological information such as temperature, wind speed, and rainfall, earthquake information such as seismic coefficient and tsunami information, and traffic information such as congestion, accidents, and road construction.

The self-driving control unit 203 creates a driving plan and, on the basis of the driving plan, controls the self-driving of the vehicle 12 driving autonomously. The self-driving control unit 203 controls the self-driving of the vehicle 12 in accordance with the area information acquired by the area information acquisition unit 202, the position information of the vehicle 12 acquired by the GPS device 31, and the driving information of the vehicle 12 acquired by the internal sensors 33. In the first embodiment, second vehicles 15 in the manual driving mode driving in the vicinity of the first vehicle 14 that is an urgent vehicle are switched to the self-driving mode (namely, the autonomous driving mode) and thereafter receive the driving information of the first vehicle 14 acquired by the acquisition device 16. The self-driving control unit 203 also controls the acceleration, deceleration, and steering of the vehicle 12 that is in the self-driving mode on the basis of these sets of information. Examples of the driving information include the driving direction, driving speed, destination, and driving route of the first vehicle 14 as well as the distance between the second vehicle 15 and the first vehicle 14.

The vital signs detection unit 204 detects an abnormality in the vital signs of the occupant of the vehicle 12. The vital signs detection unit 204 is an example of an urgent state detection unit. The vital signs detection unit 204 detects an abnormality in the vital signs of the occupant of the vehicle 12 on the basis of the vital signs detected by the vital signs detection unit 37 (see FIG. 2). In the first embodiment, the vital signs detection unit 204 detects an abnormality (i.e., determines that there is an abnormality) in the vital signs of the occupant of the vehicle 12 when, for example, the vital signs are equal to or greater than thresholds.

The urgent vehicle setting unit 205 sets the vehicle 12 as an urgent vehicle (i.e., the first vehicle 14 that is an urgent vehicle) when the emergency button 36 (see FIG. 2) has been pushed or when an abnormality in the vital signs of the occupant of the vehicle 12 has been detected by the vital signs detection unit 204.

The operation switching unit 206 switches the vehicle 12 to any of the manual driving mode, the self-driving mode, and the remote driving mode on the basis of a driving mode input signal. There are cases where the operation switching unit 206 switches the driving mode as a result of the occupant of the vehicle 12 inputting (e.g., including also selecting) the driving mode and cases where the operation switching unit 206 switches the driving mode to the self-driving mode on the basis of a switch signal from the server device 18. Moreover, there are cases where the operation switching unit 206 switches the driving mode to the remote driving mode on the basis of a switch signal from the remote operation device (not shown in the drawings). It will be noted that the operation switching unit 206 does not switch the driving mode to the remote driving mode in the case of a configuration where the vehicle 12 does not perform remote driving.

(Acquisition Device)

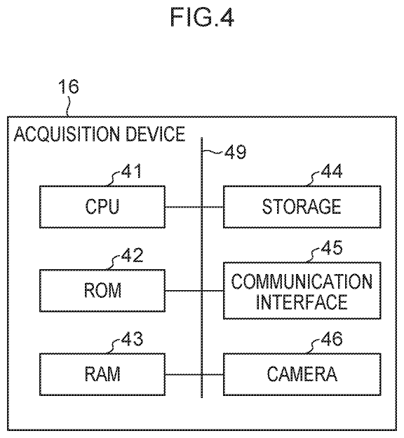

FIG. 4 is a block diagram showing the hardware configuration of devices installed in the acquisition device 16.

As shown in FIG. 4, the acquisition device 16 is configured to include a CPU 41, a ROM 42, a RAM 43, a storage 44, a communication interface 45, and a camera 46. The CPU 41, the ROM 42, the RAM 43, the storage 44, the communication interface 45, and the camera 46 are communicably connected to each other via a bus 49. The functions of the CPU 41, the ROM 42, the RAM 43, the storage 44, and the communication interface 45 are the same as those of the CPU 21, the ROM 22, the RAM 23, the storage 24, and the communication interface 25 of the vehicle control device 20.

The CPU 41 reads programs from the ROM 42 or the storage 44 and executes the programs using the RAM 43 as a work area. In the first embodiment, an urgent vehicle driving program is stored in the ROM 42 or the storage 44. The camera 46 images the plural vehicles 12 driving on the road 60 in a predetermined range.

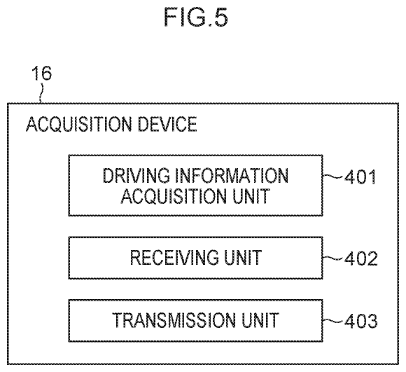

FIG. 5 is a block diagram showing an example of the functional configuration of the acquisition device 16.

As shown in FIG. 5, the acquisition device 16 has a driving information acquisition unit 401, a receiving unit 402, and a transmission unit 403. The driving information acquisition unit 401, the receiving unit 402, and the transmission unit 403 are realized by the CPU 41 reading and executing the urgent vehicle driving program stored in the ROM 42 or the storage 44.

The driving information acquisition unit 401 acquires driving information relating to the driving states of the plural vehicles 12 driving on the road 60. In the first embodiment, the driving information acquisition unit 401 acquires driving information relating to the driving state of the first vehicle 14 that is an urgent vehicle. The driving information includes, for example, information such as the driving direction, driving speed, destination, and driving route of the first vehicle 14 as well as its distance from the second vehicles 15 that are in the vicinity of the first vehicle 14.

The receiving unit 402 receives, from the plural vehicles 12 via the network N1, the area information relating to the driving states of the respective vehicles 12.

The transmission unit 403 transmits, to the server device 18 via the network N1, the driving information relating to the driving states of the plural vehicles 12. Moreover, the transmission unit 403 transmits, to the server device 18 via the network N1, the driving information relating to the driving state of the first vehicle 14 that is an urgent vehicle.

(Server Device)

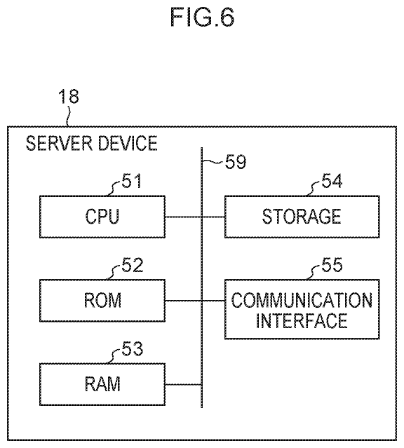

FIG. 6 is a block diagram showing the hardware configuration of devices installed in the server device 18.

As shown in FIG. 6, the server device 18 is configured to include a CPU 51, a ROM 52, a RAM 53, a storage 54, and a communication interface 55. The CPU 51, the ROM 52, the RAM 53, the storage 54, and the communication interface 55 are communicably connected to each other via a bus 59. The functions of the CPU 51, the ROM 52, the RAM 53, the storage 54, and the communication interface 55 are the same as those of the CPU 21, the ROM 22, the RAM 23, the storage 24, and the communication interface 25 of the vehicle control device 20.

The CPU 51 reads programs from the ROM 52 or the storage 54 and executes the programs using the RAM 53 as a work area. In the first embodiment, an urgent vehicle driving program is stored in the ROM 52 or the storage 54.

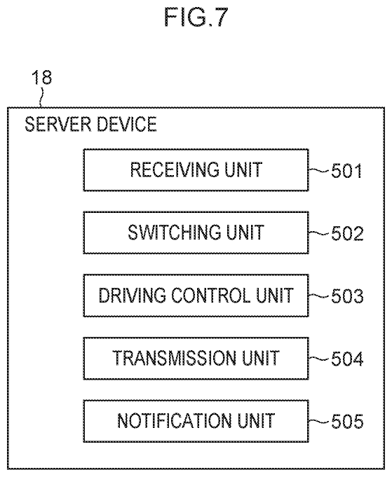

FIG. 7 is a block diagram showing an example of the functional configuration of the server device 18.

As shown in FIG. 7, the server device 18 has a receiving unit 501, a switching unit 502, a driving control unit 503, a transmission unit 504, and a notification unit 505. The receiving unit 501, the switching unit 502, the driving control unit 503, the transmission unit 504, and the notification unit 505 are realized by the CPU 51 reading and executing the urgent vehicle driving program stored in the ROM 52 or the storage 54.

The receiving unit 501 receives, from the plural vehicles 12, the area information of the respective vehicles 12. Furthermore, the receiving unit 501 receives the driving information relating to the driving states of the plural vehicles 12 and the driving information relating to the driving state of the first vehicle 14 that is an urgent vehicle.

The switching unit 502 controls the switching of the vehicles 12 to the self-driving mode (namely, the autonomous driving mode). The switching unit 502 outputs a switch signal to the vehicle control devices 20, whereby the vehicles 12 are switched from the manual driving mode or the remote driving mode to the self-driving mode. In the first embodiment, in a case where the first vehicle 14 that is an urgent vehicle has been set, the switching unit 502 performs control that switches the second vehicles 15 that are in the vicinity of the first vehicle 14 from the manual driving mode or the remote driving mode to the self-driving mode.

The driving control unit 503 controls the self-driving of the second vehicles 15 that have been switched to the self-driving mode. The driving control unit 503 performs control such as driving the second vehicles 15 or stopping the second vehicles 15 on the side of the road 60 so as to avoid the first vehicle 14. In other words, the driving control unit 503 performs control of the second vehicles 15 in the self-driving mode by which the second vehicles 15 are moved out of the driving route of the first vehicle 14 so as to not obstruct the swift and smooth driving of the first vehicle 14. In the first embodiment, the driving control unit 503 controls the acceleration, deceleration, and steering of the second vehicles 15 so as to avoid the first vehicle 14 in accordance with the driving information relating to the driving state of the first vehicle 14, the driving information relating to the driving states of the second vehicles 15, and the area information about the area around the first vehicle 14.

The transmission unit 504 transmits, to the second vehicles 15 that are in the vicinity of the first vehicle 14 (in the first embodiment, in the predetermined range of the first vehicle 14) that is an urgent vehicle, control information resulting from the driving control unit 503 for driving the second vehicles 15 so as to avoid the driving of the first vehicle 14. Furthermore, the transmission unit 504 transmits, to the second vehicles 15 that are in the vicinity of the first vehicle 14 that is an urgent vehicle, the driving information relating to the driving state of the first vehicle 14. The driving information includes, for example, the driving direction, driving speed, destination, and driving route of the first vehicle 14 as well as its distance from the second vehicles 15. The predetermined range may, for example, be set as a circular range with a radius of 200 m, 400 m, 600 m, or 800 m centered on the first vehicle 14.

The notification unit 505 notifies the occupants inside the second vehicles 15 that are in the vicinity of the first vehicle 14 (in the first embodiment, in the predetermined range of the first vehicle 14) that is an urgent vehicle of the presence of the first vehicle 14 that is an urgent vehicle. The notification unit 505 notifies, via the transmission unit 504, the occupants inside the second vehicles 15 of the presence of the first vehicle 14 that is an urgent vehicle. The occupants inside the second vehicles 15 are notified of the presence of the first vehicle 14 that is an urgent vehicle by, for example, audio that is output from the speakers 38 (see FIG. 2).

(Flow of Control)

Next, the action of the urgent vehicle driving system 10 will be described. It will be noted that in order to arrange the action in a time series, the action of the vehicle control device 20 of the vehicles 12, the action of the acquisition device 16, and the action of the server device 18 will be sequentially described.

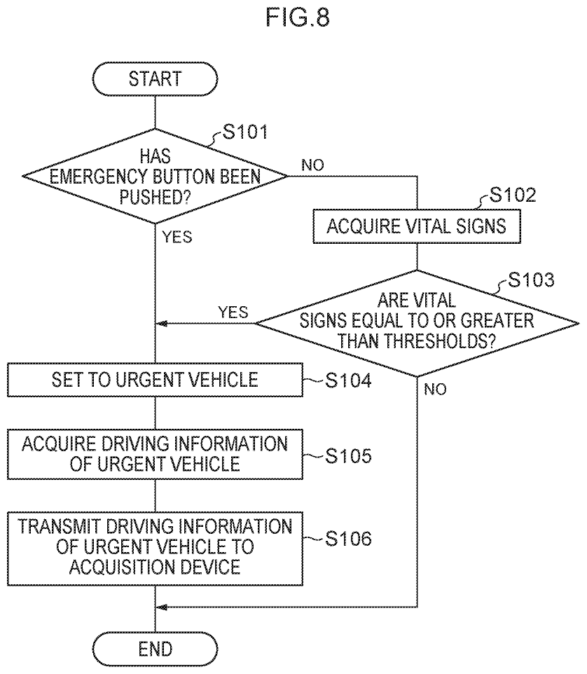

FIG. 8 is a flowchart showing the flow of an urgent vehicle driving process performed by the vehicle control device 20. The urgent vehicle driving process is performed by the CPU 21 reading the urgent vehicle driving program from the ROM 22 or the storage 24, transferring it to the RAM 23, and executing it.

In step S101 the CPU 21 judges whether or not the emergency button 36 inside the vehicle 12 has been pushed.

In a case where the emergency button 36 has not been pushed (i.e., in the case of NO in step S101), in step S102 the CPU 21 acquires the vital signs of the occupant inside the vehicle 12. In the first embodiment, any one or more vital signs such as the heart rate, blood pressure, pulse, electrocardiogram, and pupils of the occupant are detected by the vital signs detection unit 37.

In step S103 the CPU 21 judges whether or not the vital signs acquired by step S102 are equal to or greater than thresholds. The thresholds are set in regard to any one or more of the heart rate, blood pressure, pulse, electrocardiogram, and pupils of the occupant, and when the vital signs are equal to or greater than the thresholds, it is judged that the vital signs of the occupant of the vehicle 12 are abnormal.

In a case where the emergency button 36 has been pushed (i.e., in the case of YES in step S101), or in a case where the vital signs are equal to or greater than the thresholds (i.e., in the case of YES in step S103), in step S104 the CPU 21 sets the vehicle 12 as the first vehicle 14 that is an urgent vehicle.

In a case where the vital signs are not equal to or greater than the thresholds (i.e., in the case of NO in step S103), the CPU 21 ends the process based on the urgent vehicle driving program.

In step S105 the CPU 21 acquires the driving information of the first vehicle 14 that is an urgent vehicle. The driving information includes, for example, the driving direction, driving speed, destination, and driving route of the first vehicle 14 as well as its distance from the second vehicles 15 that are in the vicinity of the first vehicle 14.

In step S106 the CPU 21 transmits to the acquisition device 16 the driving information of the first vehicle 14 that is an urgent vehicle. With this, the CPU 21 ends the process based on the urgent vehicle driving program.

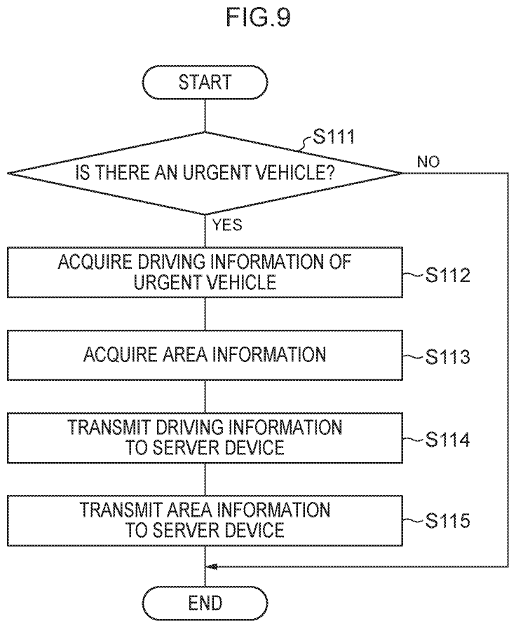

FIG. 9 is a flowchart showing the flow of an urgent vehicle driving process performed by the devices installed in the acquisition device 16. The urgent vehicle driving process is performed by the CPU 41 reading the urgent vehicle driving program from the ROM 42 or the storage 44, transferring it to the RAM 43, and executing it.

In step S111 the CPU 41 judges whether or not there is a first vehicle 14 that is an urgent vehicle.

In a case where there is a first vehicle 14 that is an urgent vehicle (i.e., in the case of YES in step S111), in step S112 the CPU 41 acquires the driving information of the first vehicle 14 that is an urgent vehicle.

In a case where there is not a first vehicle 14 that is an urgent vehicle (i.e., in the case of NO in step S111), the CPU 41 ends the process based on the urgent vehicle driving program.

In step S113, the CPU 41 acquires the area information about the area around the first vehicle 14 that is an urgent vehicle. The area information includes information not only about the second vehicles 15 driving in the vicinity of the first vehicle 14 and pedestrians but also the weather, brightness, lane width, and obstacles. Furthermore, the area information includes information such as the driving directions and driving speeds of the second vehicles 15 driving in the vicinity of the first vehicle 14 as well as the distances between the first vehicle 14 and the second vehicles 15. Moreover, the area information includes meteorological information such as temperature, wind speed, and rainfall, earthquake information such as seismic coefficient and tsunami information, and traffic information such as congestion, accidents, and road construction.

In step S114 the CPU 41 transmits to the server device 18 the driving information of the first vehicle 14 that is an urgent vehicle.

In step S115 the CPU 41 transmits to the server device 18 the area information about the area around the first vehicle 14 that is an urgent vehicle. With this, the CPU 41 ends the process based on the urgent vehicle driving program.

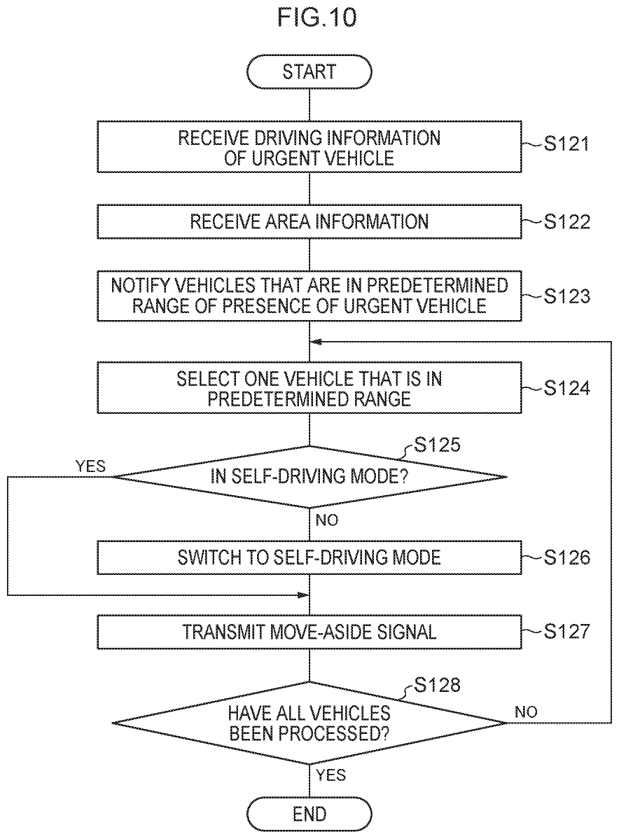

FIG. 10 is a flowchart showing the flow of an urgent vehicle driving process performed by the devices installed in the server device 18. The urgent vehicle driving process is performed by the CPU 51 reading the urgent vehicle driving program from the ROM 52 or the storage 54, transferring it to the RAM 53, and executing it.

In step S121 the CPU 51 receives from the acquisition device 16 the driving information of the first vehicle 14 that is an urgent vehicle.

In step S122 the CPU 51 receives from the acquisition device 16 the area information about the area around the first vehicle 14 that is an urgent vehicle.

In step S123, on the basis of the area information about the area around the first vehicle 14, the CPU 51 notifies the plural second vehicles 15 that are in the predetermined range around the first vehicle 14 of the presence of the first vehicle 14 that is an urgent vehicle. The predetermined range is, for example, set as a circular range with a radius of 200 m, 400 m, 600 m, or 800 m centered on the first vehicle 14. For example, if there are second vehicles 15 being driven in the manual driving mode or the remote driving mode in the vicinity of the first vehicle 14, there are cases where the driving of the first vehicle 14 will be obstructed. The predetermined range is preset as a range in which, by moving out of the way of the first vehicle 14, the second vehicles 15 will not obstruct the driving of the first vehicle 14.

In step S124 the CPU 51 selects one of the second vehicles 15 that are in the predetermined range around the first vehicle 14.

In step S125 the CPU 51 judges whether or not the one second vehicle 15 that was selected in step S124 is being driven in the self-driving mode (namely, the autonomous driving mode).

In a case where the one second vehicle 15 that was selected is not being driven in the self-driving mode (i.e., in the case of NO in step S125), in step S126 the CPU 51 switches the one second vehicle 15 that was selected to the self-driving mode. For example, in a case where the one second vehicle 15 that was selected is being driven in the manual driving mode or the remote driving mode, the second vehicle 15 is switched from the manual driving mode or the remote driving mode to the self-driving mode.

In a case where the one second vehicle 15 that was selected is being driven in the self-driving mode (i.e., in the case of YES in step S125), the CPU 51 proceeds to the process of step S127.

In step S127 the CPU 51 transmits, to the second vehicle 15 being driven in the self-driving mode, a move-aside signal for moving the second vehicle 15 out of the way of the first vehicle 14 that is an urgent vehicle. The move-aside signal is a signal for driving or stopping the second vehicle 15 being driven in the self-driving mode so as to move it out of the way of the first vehicle 14 in accordance with the driving information (destination, driving route, etc.) of the first vehicle 14 that is an urgent vehicle. Because of this, the second vehicle 15 being driven in the self-driving mode in the vicinity of the first vehicle 14 that is an urgent vehicle is moved out of the way of the first vehicle 14. That is, the second vehicle 15 is self-driven in avoidance of the first vehicle 14.

In step S128 the CPU 51 judges whether or not it has processed all the second vehicles 15 that are in the predetermined range around the first vehicle 14.

In a case where it has not processed all the second vehicles 15 in the predetermined range around the first vehicle 14 (i.e., in the case of NO in step S128), the CPU 51 returns to the process of step S124.

In a case where it has processed all the second vehicles 15 in the predetermined range around the first vehicle 14 (i.e., in the case of YES in step S128), the CPU 51 ends the process based on the urgent vehicle driving program.

As shown in FIG. 11, in a case where the first vehicle 14 that is an urgent vehicle is driving, when the second vehicles 15 that are in the predetermined range around the first vehicle 14 are being driven in the manual driving mode or the remote driving mode, the CPU 51 switches the second vehicles 15 to the self-driving mode. Then, the CPU 51 drives the second vehicles 15 in the self-driving mode so as to avoid the first vehicle 14. For this reason, the second vehicles 15 being driven in the manual driving mode or the remote driving mode in the vicinity of the first vehicle 14 that is an urgent vehicle can be smoothly moved out of the way of the first vehicle 14. Consequently, the first vehicle 14 that is an urgent vehicle can be allowed to drive swiftly and smoothly.

### Second Embodiment

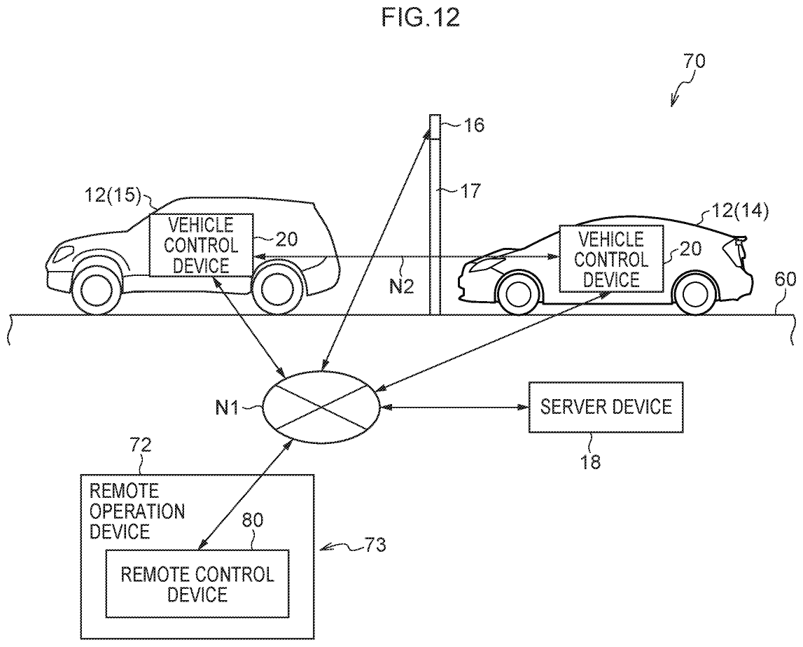

FIG. 12 is a drawing showing the schematic configuration of an urgent vehicle driving system 70 pertaining to a second embodiment. It will be noted in regard to constituent parts that are identical to those in the first embodiment that identical numbers are assigned thereto and description thereof will be omitted.

As shown in FIG. 12, the urgent vehicle driving system 70 is configured to include plural vehicles 12, an acquisition device 16, a server device 18, and a remote operation device 72 that is provided in a remote center 73. The plural vehicles 12 include a first vehicle 14 that is an urgent vehicle and a second vehicle 15 that is located in a predetermined range from the first vehicle 14.

The remote operation device 72 has a remote control device 80. In the urgent vehicle driving system 70, the vehicle control device 20 of the first vehicle 14, the vehicle control device 20 of the second vehicle 15, the acquisition device 16, the server device 18, and the remote control device 80 of the remote operation device 72 are connected to each other via a network N1. Furthermore, the vehicle control devices 20 are configured to be capable of directly communicating with each other by vehicle-to-vehicle communication N2.

The vehicles 12 are each configured to be capable of executing a self-driving mode (namely, an autonomous driving mode) in which the vehicle 12 drives autonomously on the basis of a driving plan generated by the vehicle control device 20, a remote driving mode based on operation of the remote operation device 72 by a remote driver, and a manual driving mode based on operation by an occupant (i.e., a driver) of the vehicle 12.

(Remote Operation Device)

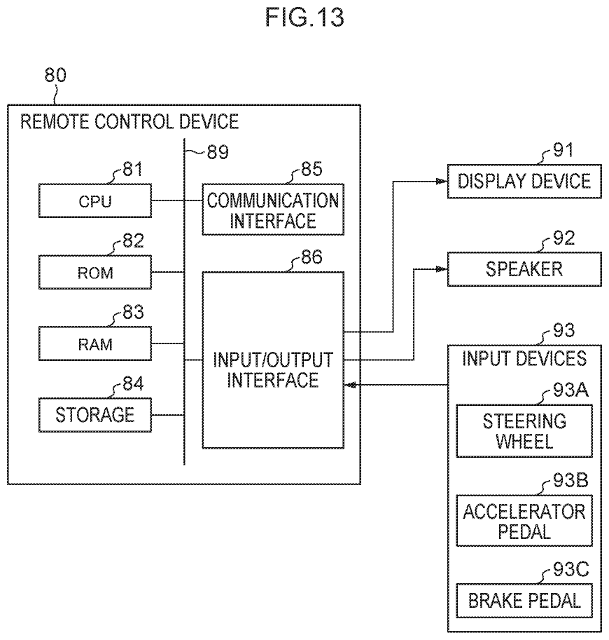

FIG. 13 is a block diagram showing the hardware configuration of devices installed in the remote operation device 72. The remote operation device 72 has, in addition to the remote control device 80, a display device 91, a speaker 92, and input devices 93.

The remote control device 80 is configured to include a CPU 81, a ROM 82, a RAM 83, a storage 84, a communication interface 85, and an input/output interface 86. The CPU 81, the ROM 82, the RAM 83, the storage 84, the communication interface 85, and the input/output interface 86 are communicably connected to each other via a bus 89. The functions of the CPU 81, the ROM 82, the RAM 83, the storage 84, the communication interface 85, and the input/output interface 86 are the same as those of the CPU 21, the ROM 22, the RAM 23, the storage 24, the communication interface 25, and the input/output interface 26 of the vehicle control device 20.

The CPU 81 reads programs from the ROM 82 or the storage 84 and executes the programs using the RAM 83 as a work area. In the second embodiment, an urgent vehicle driving program is stored in the ROM 82.

The display device 91, the speaker 92, and the input devices 93 are connected via the input/output interface 86 to the remote control device 80 of the second embodiment. It will be noted that the display device 91, the speaker 92, and the input devices 93 may also be directly connected to the bus 89.

The display device 91 is a liquid crystal monitor for displaying images captured by the cameras 32A of the vehicles 12 and various types of information pertaining to the vehicles 12. The display device 91 is an example of a display unit. In the second embodiment, the driving of the first vehicle 14 and the second vehicles 15 that are in the vicinity of the first vehicle 14 are displayed in a bird's-eye view on the display device 91. More specifically, the CPU 81 performs image processes for displaying in a bird's-eye view the driving of the first vehicle 14 that is an urgent vehicle and the second vehicles 15 that are in the vicinity of the first vehicle 14 on the basis of the images captured by the cameras 32A and transmitted from each of the vehicle control devices 20. Image information on which these image processes have been performed is displayed on the display device 91.

The speaker 92 plays back audio that has been recorded together with the images by microphones (not shown in the drawings) belonging to the cameras 32A of the vehicles 12.

The input devices 93 are controllers for the remote driver utilizing the remote operation device 72 to operate. The input devices 93 include a steering wheel 93A serving as a switch that steers steering wheels of the vehicles 12, an accelerator pedal 93B serving as a switch that accelerates the vehicles 12, and a brake pedal 93C serving as a switch that decelerates the vehicles 12. It will be noted that the configurations of each of the input devices 93 are not limited. For example, a lever switch may also be provided instead of the steering wheel 93A. Furthermore, for example, a push button switch and/or a lever switch may also be provided instead of the accelerator pedal 93B and/or the brake pedal 93C.

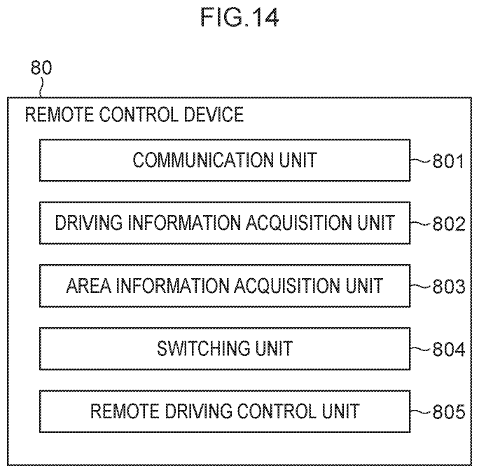

FIG. 14 is a block diagram showing an example of the functional configuration of the remote control device 80.

As shown in FIG. 14, the remote control device 80 has a communication unit 801, a driving information acquisition unit 802, an area information acquisition unit 803, a switching unit 804, and a remote driving control unit 805.

The communication unit 801 performs communication with the vehicles 12 (in the second embodiment, the second vehicles 15) utilizing remote driving, communication with the acquisition device 16, and communication with the server device 18. The images and audio of the cameras 32A transmitted from the vehicle control devices 20 and vehicle information such as vehicle speed are received by the communication unit 801. The received images and vehicle information are displayed on the display device 91, and the audio information is output from the speaker 92.

The driving information acquisition unit 802 acquires driving information relating to the driving states of the plural vehicles 12 driving on the road 60. In the second embodiment, the driving information acquisition unit 802 acquires driving information relating to the driving state of the first vehicle 14 that is an urgent vehicle. The driving information includes, for example, information such as the driving direction, driving speed, destination, and driving route of the first vehicle 14 as well as its distance from the second vehicles 15 that are in the vicinity of the first vehicle 14.

The area information acquisition unit 803 acquires area information about the area around the vehicles 12 utilizing remote driving (in the second embodiment, the second vehicles 15). The area information includes information not only about the other vehicles 12 driving in the vicinity of the vehicle 12 and pedestrians but also the weather, brightness, lane width, and obstacles. Furthermore, the area information includes information such as the driving directions and driving speeds of the other vehicles 12 driving in the vicinity of the vehicle 12 as well as the distances between the plural vehicles 12. Moreover, the area information includes meteorological information such as temperature, wind speed, and rainfall, earthquake information such as seismic coefficient and tsunami information, and traffic information such as congestion, accidents, and road construction.

The switching unit 804 switches the vehicles 12 (in the second embodiment, the second vehicles 15) to the remote driving mode. The switching unit 804 switches the vehicles 12 from the manual driving mode or the self-driving mode (namely, the autonomous driving mode) to the remote driving mode by outputting a switch signal to the vehicle control devices 20 of the vehicles 12.

The remote driving control unit 805, in a case where remote driving based on operation by the remote driver is performed, controls the remote driving of the vehicle 12 by transmitting control information for performing remote driving via the communication unit 801 to the vehicle control device 20 on the basis of signals input from each of the input devices 93.

(Server Device)

The server device 18 has the same hardware configuration compared to that of the urgent vehicle driving system 10 of the first embodiment, but its functional configuration is different. In the second embodiment, the server device 18 has a receiving unit 501, a transmission unit 504, and a notification unit 505 (see FIG. 7). That is, in the second embodiment, the server device 18 does not have a switching unit or a driving control unit.

(Flow of Control)

Next, the action of the urgent vehicle driving system 70 will be described. It will be noted that in the urgent vehicle driving system 70 the action of the vehicle 12 of the first embodiment (see FIG. 8) and the action of the acquisition device 16 (see FIG. 9) are the same. In the urgent vehicle driving system 70, compared to the first embodiment, it is the action of the server device 18 and the action of the remote operation device 72 that are different.

The CPU 51 of the server device 18 performs the processes of step S121 to step S123 of the flowchart shown in FIG. 10 and thereafter ends the process based on the urgent vehicle driving program.

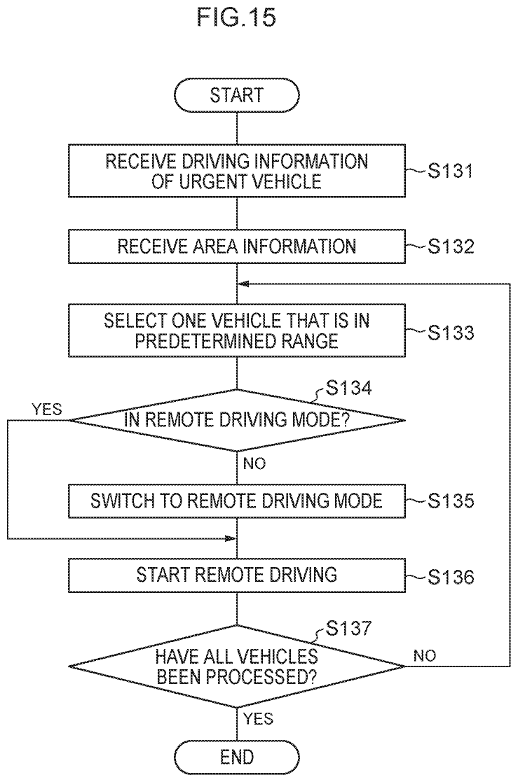

FIG. 15 is a flowchart showing the flow of an urgent vehicle driving process performed by the devices installed in the remote operation device 72. The urgent vehicle driving process is performed by the CPU 81 reading the urgent vehicle driving program from the ROM 82 or the storage 84, transferring it to the RAM 83, and executing it.

In step S131 the CPU 81 receives the driving information of the first vehicle 14 that is an urgent vehicle. The driving information of the first vehicle 14 is received from the server device 18 or the acquisition device 16.

In step S132 the CPU 81 receives the area information about the area around the first vehicle 14 that is an urgent vehicle. The area information about the area around the first vehicle 14 is received from the server device 18 or the acquisition device 16.

In step S133 the CPU 81 selects one of the second vehicles 15 that are in the predetermined range around the first vehicle 14 that is an urgent vehicle. The predetermined range is, for example, set as a circular range with a radius of 200 m, 400 m, 600 m, or 800 m centered on the first vehicle 14.

In step S134 the CPU 81 judges whether or not the one second vehicle 15 that was selected in step S133 is being driven in the remote driving mode.

In a case where the one second vehicle 15 that was selected is not being driven in the remote driving mode (i.e., in the case of NO in step S134), in step S135 the CPU 81 switches the one second vehicle 15 that was selected to the remote driving mode. For example, in a case where the one second vehicle 15 that was selected is being driven in the manual driving mode or the self-driving mode (namely, the autonomous driving mode), the second vehicle 15 is switched from the manual driving mode or the self-driving mode to the remote driving mode.

In a case where the one second vehicle 15 that was selected is being driven in the remote driving mode (i.e., in the case of YES in step S134), the CPU 81 proceeds to the process of step S136.

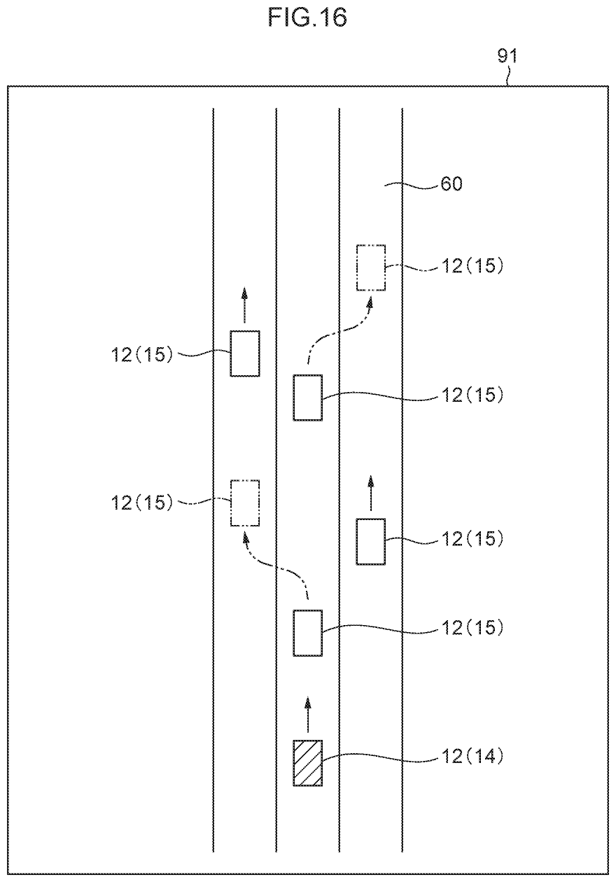

In step S136, the CPU 81 starts remote driving of the one second vehicle 15 that was selected. For example, the CPU 81 drives the second vehicle 15 in the remote driving mode so as to move it out of the way of the first vehicle 14 that is an urgent vehicle. That is, the second vehicle 15 is remotely driven in avoidance of the first vehicle 14. At this time, as shown in FIG. 16, the driving of the first vehicle 14 that is an urgent vehicle and the driving of the second vehicle 15 that is in the vicinity of the first vehicle 14 are displayed in a bird's-eye view on the display device 91. For this reason, the second vehicle 15 can be driven or stopped in the remote driving mode so as to move it out of the way of the first vehicle 14 in accordance with the driving information (destination, driving route, etc.) of the first vehicle 14 that is an urgent vehicle.

In step S137 the CPU 81 judges whether or not it has processed all the second vehicles 15 that are in the predetermined range around the first vehicle 14.

In a case where it has not processed all the second vehicles 15 that are in the predetermined range around the first vehicle 14 (i.e., in the case of NO in step S137), the CPU 81 returns to the process of step S133.

In a case where it has processed all the second vehicles 15 that are in the predetermined range around the first vehicle 14 (i.e., in the case of YES in step S137), the CPU 81 ends the process based on the urgent vehicle driving program.

FIG. 16 shows the image displayed on the display device 91. As shown in FIG. 16, in a case where the first vehicle 14 that is an urgent vehicle is driving, when the second vehicles 15 that are in the predetermined range around the first vehicle 14 are being driven in the manual driving mode or the self-driving mode, the CPU 81 switches the second vehicles 15 to the remote driving mode. Then, the CPU 81 drives the second vehicles 15 in the remote driving mode so as to avoid the first vehicle 14. For this reason, the second vehicles 15 being driven in the manual driving mode or the self-driving mode in the vicinity of the first vehicle 14 that is an urgent vehicle can be smoothly moved out of the way of the first vehicle 14. Consequently, the first vehicle 14 that is an urgent vehicle can be allowed to drive swiftly and smoothly.

Urgent vehicle driving systems of the first and second embodiments have been described above. However, the disclosure is not limited to the above embodiments. Various improvements to and modifications thereof are possible.

In the urgent vehicle driving system 10 of the first embodiment, only the second vehicles 15 that are in the predetermined range around the first vehicle 14 that is an urgent vehicle are switched to the self-driving mode, but the disclosure is not limited to this. For example, the urgent vehicle driving system may also be configured to switch the first vehicle that is an urgent vehicle to the self-driving mode (namely, the autonomous driving mode) in a case where the first vehicle that is an urgent vehicle is being driven in the manual driving mode or the remote driving mode. Furthermore, for example, the urgent vehicle driving system may also be configured to switch the first vehicle that is an urgent vehicle to the remote driving mode in a case where the first vehicle that is an urgent vehicle is being driven in the manual driving mode or the self-driving mode. Furthermore, for example, the urgent vehicle driving system may also be configured to switch the first vehicle to the self-driving mode or the remote driving mode in a case where the first vehicle that is an urgent vehicle is being driven in the manual driving mode and an abnormality in the driver of the first vehicle has been detected by the vital signs detection unit.

In the urgent vehicle driving system 10 of the first embodiment, the server device 18 switches to the self-driving mode the second vehicles 15 that are in the predetermined range around the first vehicle 14 that is an urgent vehicle, but the disclosure is not limited to this. For example, the urgent vehicle driving system may also be configured in such a way that the switching unit (i.e., the operation switching unit) provided inside the second vehicles switches the second vehicles to the self-driving mode when the second vehicles have been notified by the server device of the presence of the first vehicle 14.

In the urgent vehicle driving system 10 of the first embodiment, the second vehicles 15 being driven in the manual driving mode or the remote driving mode in the predetermined range around the first vehicle 14 that is an urgent vehicle are switched to the self-driving mode, but the disclosure is not limited to this. For example, the urgent vehicle driving system may also be configured to switch to the self-driving mode only the second vehicles 15 being driven in the manual driving mode in the predetermined range around the first vehicle 14 that is an urgent vehicle and to drive, with the remote operation device so as to avoid the first vehicle 14 that is an urgent vehicle, the second vehicles 15 being driven in the remote driving mode.

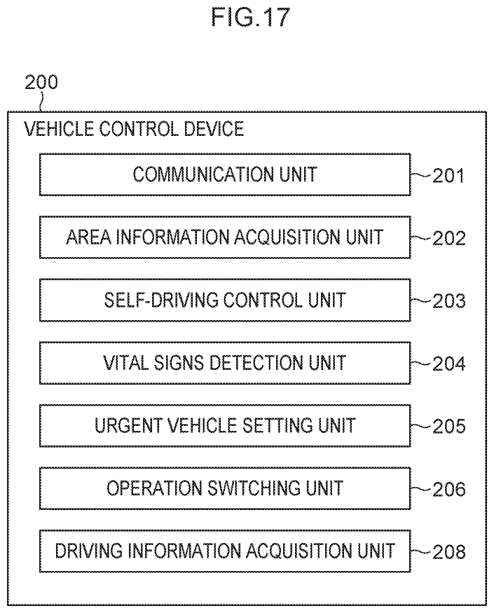

In the urgent vehicle driving systems 10 and 70 of the first and second embodiments, the acquisition device 16 acquires the driving information relating to the driving state of the first vehicle 14 that is an urgent vehicle, but the disclosure is not limited to this. FIG. 17 is a block diagram showing an example of the functional configuration of vehicles in an urgent vehicle driving system pertaining to a third embodiment. As shown in FIG. 17, vehicle control devices 200 of the second vehicles 15 are each provided with a driving information acquisition unit 208 serving as an acquisition unit that acquires, by the vehicle-to-vehicle communication N2 between the first vehicle 14 and the second vehicle 15, the driving information relating to the driving state of the first vehicle 14 that is an urgent vehicle. Because of this, the second vehicles 15 that are in the predetermined range around the first vehicle 14 acquire, by the driving information acquisition unit 208, the driving information relating to the driving state of the first vehicle 14 that is an urgent vehicle. The driving information acquisition unit 208 may also be used in conjunction with the driving information acquisition unit 401 (see FIG. 5) of the acquisition device 16. Furthermore, just the driving information acquisition unit 208 may also be provided without the driving information acquisition unit 401 of the acquisition device 16 being provided.

In the urgent vehicle driving system 70 of the second embodiment, only the second vehicles 15 that are in the predetermined range around the first vehicle 14 that is an urgent vehicle are switched to the remote driving mode, but the disclosure is not limited to this. For example, the urgent vehicle driving system may also be configured to switch the first vehicle to the remote driving mode in a case where the first vehicle that is an urgent vehicle is being driven in the manual driving mode or the self-driving mode. Furthermore, for example, the urgent vehicle driving system may also be configured to switch the first vehicle to the self-driving mode in a case where the first vehicle that is an urgent vehicle is being driven in the manual driving mode or the remote driving mode.

In the urgent vehicle driving system 70 of the second embodiment, the server device 18 notifies the second vehicles 15 that are in the predetermined range around the first vehicle 14 that is an urgent vehicle of the presence of the first vehicle 14, but the disclosure is not limited to this. For example, the urgent vehicle driving system may also be configured in such a way that the remote operation device 72 notifies the second vehicles 15 that are in the predetermined range around the first vehicle 14 that is an urgent vehicle of the presence of the first vehicle 14.

In the urgent vehicle driving system 70 of the second embodiment, the second vehicles 15 being driven in the manual driving mode or the self-driving mode in the predetermined range around the first vehicle 14 that is an urgent vehicle are switched to the remote driving mode, but the disclosure is not limited to this. For example, the urgent vehicle driving system may also be configured to switch to the remote driving mode only the second vehicles 15 being driven in the manual driving mode in the predetermined range around the first vehicle 14 that is an urgent vehicle and to use the server device to control the driving of the second vehicles 15 being driven in the self-driving mode so as to avoid the first vehicle 14 that is an urgent vehicle.

It will be noted that in each of the above embodiments various types of processors other than a CPU may also execute the urgent vehicle driving process that the CPUs 21, 41, 51, and 81 execute by reading software (e.g., programs). Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the urgent vehicle driving process may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Furthermore, in each of the above embodiments, configurations where the driving programs are stored (e.g., installed) beforehand in the ROMs 21, 41, 51, and 81 or the storages 24, 44, 54, and 84 were described, but the urgent vehicle driving system is not limited to this. The programs may also be provided in forms in which they are recorded in a recording medium such as a compact disc read-only memory (CD-ROM), a digital versatile disk read-only memory (DVD-ROM), and a universal serial bus (USB) memory. Furthermore, the programs may also take forms in which they are downloaded via a network from an external device.

The disclosure of Japanese Patent Application No. 2019-138982 filed on Jul. 29, 2019, is incorporated in its entirety by reference herein.

All documents, patent applications, and technical standards mentioned in this specification are incorporated by reference herein to the same extent as if each document, patent application, or technical standard were specifically and individually indicated to be incorporated by reference.

What is claimed is:

1. An urgent vehicle driving system, comprising:
an acquisition unit that acquires driving information relating to a driving state of a first vehicle that is an urgent vehicle; and
a switching unit that, on the basis of the driving information acquired by the acquisition unit, switches a second vehicle, which is in a manual driving mode or a remote driving mode and is located within a predetermined range from the first vehicle, to an autonomous driving mode configured to avoid the first vehicle.

2. An urgent vehicle driving system, comprising:
an acquisition unit that acquires driving information relating to a driving state of a first vehicle that is an urgent vehicle; and
a switching unit that, on the basis of the driving information acquired by the acquisition unit, switches a second vehicle, which is in a manual driving mode or an autonomous driving mode and is located within a predetermined range from the first vehicle, to a remote driving mode configured to avoid the first vehicle.

3. The urgent vehicle driving system according to claim 1, wherein the switching unit is provided at the second vehicle or at a server device.

4. The urgent vehicle driving system according to claim 2, wherein the switching unit is provided at a remote center at which remote driving of the second vehicle is performed.

5. The urgent vehicle driving system according to claim 1, wherein the acquisition unit is provided at a road on which the first vehicle is driving.

6. The urgent vehicle driving system according to claim 2, wherein the acquisition unit is provided at a road on which the first vehicle is driving.

7. The urgent vehicle driving system according to claim 1, wherein the acquisition unit is provided at the second vehicle, and the driving information is acquired by communication between the first vehicle and the second vehicle.

8. The urgent vehicle driving system according to claim 2, wherein the acquisition unit is provided at the second vehicle, and the driving information is acquired by communication between the first vehicle and the second vehicle.

9. The urgent vehicle driving system according to claim 1, further comprising an urgent state detection unit that detects an urgent state of the first vehicle, wherein the acquisition unit acquires the driving information in a case in which the urgent state detection unit has detected that the first vehicle is in an emergency state.

10. The urgent vehicle driving system according to claim 2, further comprising an urgent state detection unit that detects an urgent state of the first vehicle, wherein the acquisition unit acquires the driving information in a case in which the urgent state detection unit has detected that the first vehicle is in an emergency state.

11. The urgent vehicle driving system according to claim 9, wherein the urgent state detection unit is an emergency button that is provided inside the first vehicle and that is pushed at a time of an emergency.

12. The urgent vehicle driving system according to claim 10, wherein the urgent state detection unit is an emergency button that is provided inside the first vehicle and that is pushed at a time of an emergency.

13. The urgent vehicle driving system according to claim 9, wherein the urgent state detection unit is a biometric information detection unit that is configured to detect an abnormal state in a driver of the first vehicle.

14. The urgent vehicle driving system according to claim 10, wherein the urgent state detection unit is a biometric information detection unit that is configured to detect an abnormal state in a driver of the first vehicle.

15. The urgent vehicle driving system according to a claim 1, further comprising a notification unit that notifies an occupant inside the second vehicle of the presence of the first vehicle.

16. The urgent vehicle driving system according to a claim 2, further comprising a notification unit that notifies an occupant inside the second vehicle of the presence of the first vehicle.

17. The urgent vehicle driving system according to claim 2, wherein the remote center, at which remote driving of the second vehicle is performed, is provided with a display unit that displays, in bird's-eye view, travel of the first vehicle and the second vehicle.

18. A server device, comprising:
an acquisition unit that acquires driving information relating to a driving state of a first vehicle that is an urgent vehicle; and
a switching unit that, on the basis of the driving information acquired by the acquisition unit, switches a second vehicle, which is in a manual driving mode or a remote driving mode and is located within a predetermined range from the first vehicle, to an autonomous driving mode configured so as to avoid the first vehicle.

19. An urgent vehicle driving program that is executable by a computer to perform:
a step of acquiring driving information relating to a driving state of a first vehicle that is an urgent vehicle; and
a step of switching, on the basis of the driving information, a second vehicle, which is in a manual driving mode or a remote driving mode and is located within a predetermined range from the first vehicle, to an autonomous driving mode configured to avoid the first vehicle.
